(19) United States
(12) Patent Application Publication
(10) Pub. No.: US 2009/0187588 A1
(43) Pub. Date: Jul. 23, 2009

(54) DISTRIBUTED INDEXING OF FILE CONTENT

(75) Inventors: Albert J. K. Thambiratnam, Beijing (CN); Frank Seide, Hamburg (DE)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/018,203

(22) Filed: Jan. 23, 2008

(51) Int. Cl. G06F 17/30

(52) U.S. Cl. 707/102; 707/E17.005

(57) ABSTRACT

Described herein is technology for, among other things, distributed indexing of file content. Content-based indexing the file involves determining whether content-based index information for the file is available from an external source. This avoids repeating already-performed content analysis, which is time consuming and computationally intensive especially for non-text files. The content-based index information, if it is available, is received from the external source and may be stored. If the content-based index information is not available or is not complete, content-based index information for the file is generated and stored. Moreover, the generated content-based index information is shared with the external source. Once content analysis of the file is performed to generate content-based index information for the file, the content-based index information is available and sharable as needed. There is no need to repeat the same content analysis on the file.

### BACKGROUND

Information is being collected in various types of devices (e.g., computers, servers, storage media, media players, phones, etc.) for private use and/or public use. The amount of information continuous to grow. This growth poses challenges for accessing information of interest and for determining what information is available.

Creating an index for this information aids in accessing information of interest and in determining what information is available. Typically, this information includes several types of files. Text files, audio files, video files, image files, and graphics files are examples of file types. Content-based index information and noncontent-based index information are types of index information that may be included in the index for the files. Content-based index information refers to index information generated from analyzing the content of a file. Noncontent-based index information refers to index information generated from any data associated with a file, other than the file's content. Meta-data, file name, and file description are examples of sources for the noncontent-based index information.

Indexing implementations have been deployed for operation at a network level (e.g., Internet index search engine) and for operation at a device level (e.g., computer index search engine). The usefulness of these indexing implementations is dependent on several factors such as scope of its index and the type of index information included in its index. The number of files indexed and the variety of those files reflect the scope of an index. Since content-based index information generally provides more knowledge of a file than noncontent-based index information, it is desirable for the index to have content-based index information for the files.

Although content-based index information is preferred, there are problems associated with inclusion of content-based index information in an index. While generation of content-based index information for text files is practical in terms of accuracy, required time effort, and required computational resources, this is not the case for non-text files (e.g., audio files, video files, image files, and graphics files). The accuracy of content-based index information for non-text files may vary widely and may be unusable in certain cases. Generation of content-based index information for non-text files requires extensive computational resources and is time consuming. In the case of indexing which is executed as a background operation, the generation of content-based index information for non-text files may interfere with normal usage patterns because too much of the computational resources are utilized by indexing or may not be accomplished because periods of unused and available computational resources are insufficient to support indexing.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, distributed indexing of file content. It is desired to create an index for a file based on its content. The file may be a text file or a non-text file (e.g., an audio file, a video file, an image file, a graphics file, etc.). Content-based indexing the file involves determining whether content-based index information for the file is available from an external source. Any single device and any network of devices are examples of the external source. This avoids repeating already-performed content analysis, which is time consuming and computationally intensive especially for non-text files. The content-based index information, if it is available, is received from the external source and may be stored. If the content-based index information is not available or is not complete, content-based index information for the file is generated and stored. Moreover, the generated content-based index information is shared with the external source. Once content analysis of the file is performed to generate content-based index information for the file, the content-based index information is available and sharable as needed. There is no need to repeat the same content analysis on the file.

Thus, embodiments provide a practical manner of content-based indexing text files and non-text files by distributing index generation and sharing the result of the distributed index generation. Embodiments enable the content-based index information to be varied in various ways. Performance of different types of content analyses, use of numerous parameter settings for the content analysis, and aggregating performances of content analysis on different portions of the file are examples of varying the content-based index information.

### BRIEF DESCRIPTION OF THE DRAWINGS

The accompanying drawings, which are incorporated in and form a part of this specification, illustrate various embodiments and, together with the description, serve to explain the principles of the various embodiments.

FIG. 1 is a block diagram of a centralized index source environment, in accordance with various embodiments.

FIG. 2 is a block diagram of a decentralized index source environment, in accordance with various embodiments.

FIG. 3 illustrates a flowchart for content-based indexing a file, in accordance with various embodiments.

FIG. 4 illustrates a flowchart for content-based indexing a file, where different portions of the file are indexed separately, in accordance with various embodiments.

FIG. 5 illustrates a flowchart for content-based indexing a file, where the content-based indexing includes various index modes each corresponding to a different type of content analysis, in accordance with various embodiments.

FIG. 6 illustrates a flowchart for content-based indexing a file, where the content-based indexing includes various index manifestations each corresponding to performance of content analysis using a different parameter setting, in accordance with various embodiments.

### DETAILED DESCRIPTION

Reference will now be made in detail to the preferred embodiments, examples of which are illustrated in the accompanying drawings. While the disclosure will be described in conjunction with the preferred embodiments, it will be understood that they are not intended to limit the disclosure to these embodiments. On the contrary, the disclosure is intended to cover alternatives, modifications and equivalents, which may be included within the spirit and scope of the disclosure as defined by the claims. Furthermore, in the detailed description, numerous specific details are set forth in order to provide a thorough understanding of the disclosure. However, it will be obvious to one of ordinary skill in the art that the disclosure may be practiced without these specific details. In other instances, well known methods, procedures, components, and circuits have not been described in detail as not to unnecessarily obscure aspects of the disclosure.

### Overview

Content-based indexing a file requires more effort than noncontent-based indexing the file, especially for a non-text file (e.g., an audio file, a video file, an image file, a graphics file, etc.). However, if index generation is distributed and if the result of the distributed index generation is shared, content-based indexing is feasible for any type of file. Described herein is technology for, among other things, distributed indexing of file content. The file may be a text file or a non-text file (e.g., an audio file, a video file, an image file, a graphics file, etc.).

In accordance with various embodiments, content-based indexing the file involves determining whether content-based index information for the file is available from an external source. Any single device and any network of devices are examples of the external source. This avoids repeating already-performed content analysis, which is time consuming and computationally intensive especially for non-text files. The content-based index information, if it is available, is received from the external source and may be stored. If the content-based index information is not available or is not complete, content-based index information for the file is generated and stored. Moreover, the generated content-based index information is shared with the external source. Once content analysis of the file is performed to generate content-based index information for the file, the content-based index information is available and sharable as needed. There is no need to repeat the same content analysis on the file.

A practical manner of content-based indexing files is provided by distributing index generation and sharing the result of the distributed index generation. The content-based index information may be varied in various ways. Performance of different types of content analyses, use of numerous parameter settings for the content analysis, and aggregating performances of content analysis on different portions of the file are examples of varying the content-based index information.

The following discussion will begin with a description of index source environments for various embodiments. Discussion will then proceed to descriptions of distributed content-based indexing techniques.

### Index Source Environments

In accordance with various embodiments, the time and computational burden of generating content-based index information is distributed to numerous devices of any type. Content-based index information refers to index information generated from analyzing the content of a file. Moreover, the content-based index information generated by one device is shared with other devices. If a first device has already performed content analysis on a file to generate content-based index information for the file, there is no need for a second device to repeat the same content analysis of the file since the content-based index information generated by the first device is available and sharable with the second device. That is, an external source may provide the content-based index information for the file to avoid the time and computational burden of content analyzing the file to generate the content-based index information. There is collaboration to ensure non-duplication of burdensome generation of content-based index information.

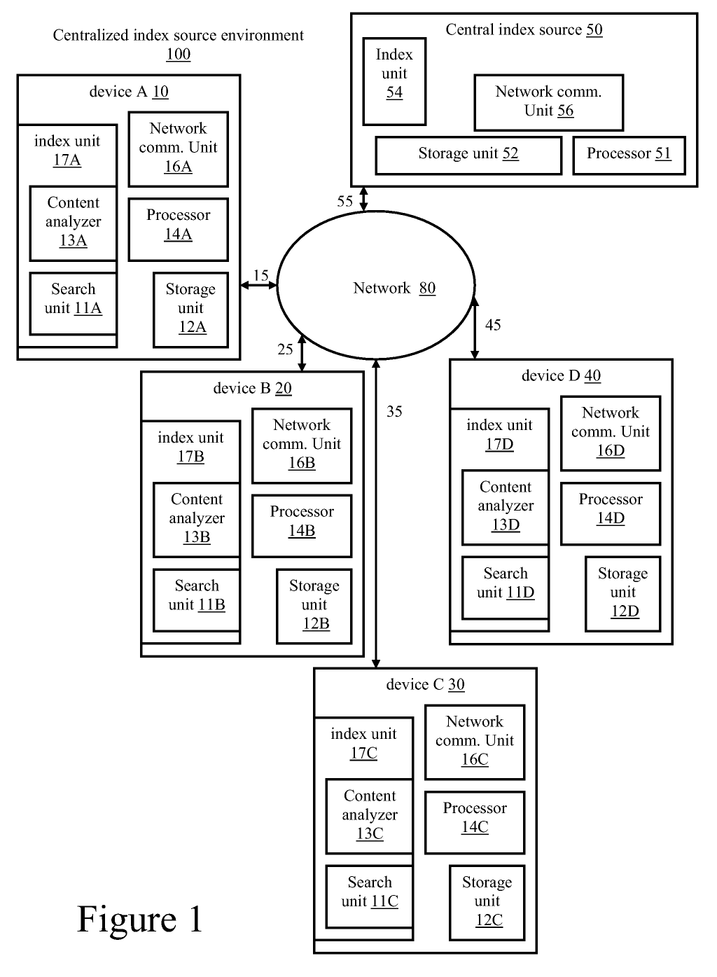

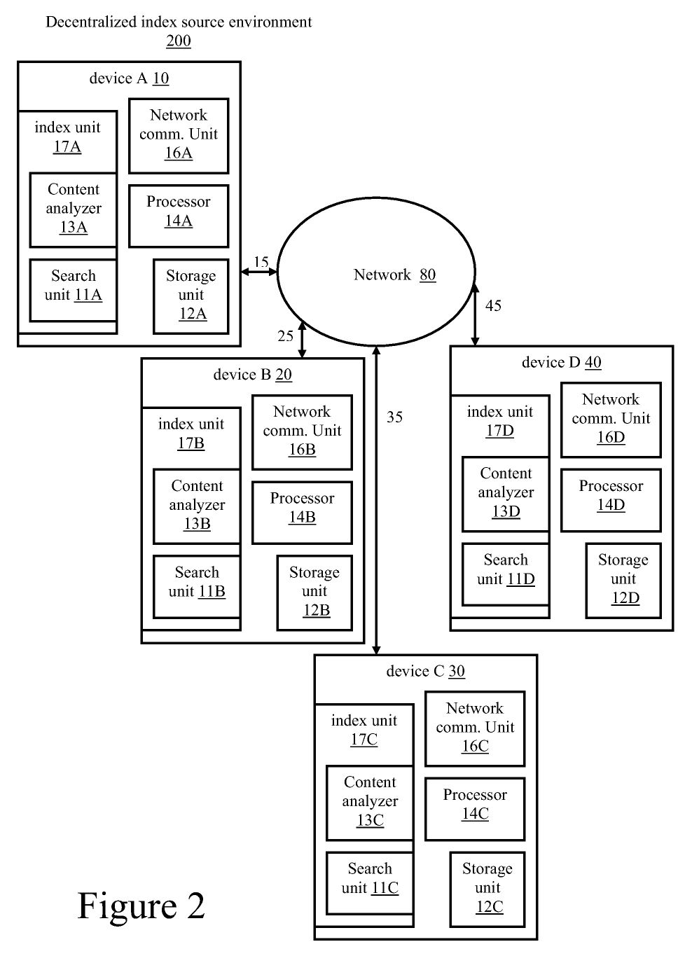

The external source may be of any type. Examples of the external source include computers, servers, storage media, media players, and phones. In an embodiment, the external source is implemented as a centralized index source. That is, content-based index information for files is collected at a centralized index source, which receives requests for content-based index information for files and responds to these requests by sending the requested content-based index information if available. This centralized index source environment is depicted in FIG. 1 and described in detail below. In an embodiment, the external source is implemented as a decentralized index source. That is, content-based index information for files is stored in a distributed manner among numerous decentralized index sources. Each decentralized index source shares its respective content-based index information as needed. This decentralized index source environment is depicted in FIG. 2 and described in detail below.

FIG. 1 is a block diagram of a centralized index source environment 100, in accordance with various embodiments. As depicted in FIG. 1, the centralized index source environment 100 includes a central index source 50 and a plurality of devices 10, 20, 30, and 40. The central index source 50 and the plurality of devices 10, 20, 30, and 40 are coupled to a network 80. The network 80 may be the Internet. The devices 10, 20, 30, and 40 may be any type of device. Computers, servers, storage media, media players, and phones are examples of device types. It should be understood that the centralized index source environment 100 may have other configurations.

Each one of device A 10, device B 20, device C 30, and device D 40 includes a processor (e.g., processors 14A-14D respectively), an indexing unit (e.g., index units 17A-17D respectively), a storage unit (e.g., storage units 12A-12D respectively), and a network communication unit (e.g., network communication units 16A-16D respectively). Moreover, device A 10, device B 20, device C 30, and device D 40 are coupled to the network 80 via connection 15, connection 25, connection 35, and connection 45, respectively. The connections 15, 25, 35, and 45 may be wired or wireless.

Each index unit 17A-17D respectively is operable to utilize the respective processor 14A-14D to request and receive content-based index information for files from the central index source 50, which is an external source of content-based index information. The received content-based index information may be stored in the respective storage unit 12A-12D. Further, each indexing unit 17A-17D is operable to utilize the respective processor 14A-14D to generate content-based index information for files. The generated content-based index information may be stored in the respective storage unit 12A-12D. Moreover, the generated content-based index information is shared with the central index source 50. As a result, the generated content-based index information may be shared with any of the devices 10, 20, 30, and 40 via the central index source 50. Also, each indexing unit 17A-17D is operable to utilize the respective processor 14A-14D to create an index comprising the received content-based index information from the central index source 50 and the generated content-based index information.

Instead of sending to the central index source 50 the file whose content-based index information is being requested from the central index source 50 or the file whose content-based index information has been generated, a unique identifier for the file is sent, in an embodiment. It may be unfeasible or inconvenient to send the file, especially if the file has a large amount of content. The unique identifier is smaller than the file. To maintain private the content of the file, the unique identifier identifies the file without disclosing content of the file. In an embodiment, each indexing unit 17A-17D is operable to utilize the respective processor 14A-14D to create a unique hash (e.g., a MD5 (Message-Digest algorithm 5) hash) of the file, where the hash is the unique identifier. The hash is generally the same for any two files that have the same content. For speed, convenience, and privacy, the received content-based index information of a file is associated with the hash of the file. Similarly, the generated content-based index information of a file is associated with the hash of the file.

In an embodiment, a security feature is added to the content-based index information of a file. The security feature may be a digital signature. The security feature of the received content-based index information from the central index source 50 is evaluated to determine whether it is trustworthy. Based on the evaluation, a decision is made whether to store and use the received content-based index information. In an embodiment, each indexing unit 17A-17D is operable to utilize the respective processor 14A-14D to evaluate the security feature and to add the security feature to the content-based index information that is generated.

In an embodiment, each one of device A 10, device B 20, device C 30, and device D 40 is operable to sign the content-based index information with the digital signature of the indexing tool (e.g., software) used to generate the content-based index information shared with the central index source 50. This allows the central index source 50 to determine the quality and to determine the trustworthiness of the content-based index information.

Each indexing unit 17A-17D includes a content analyzer (e.g., content analyzers 11A-11D respectively) and a search unit 13 (e.g., search units 13A-13D respectively), in an embodiment. Each search unit 13A-13D is operable to utilize the respective processor 14A-14D to search the index comprising the received content-based index information from the central index source 50 and the generated content-based index information.

Continuing, each content analyzer 11A-11D is operable to utilize the respective processor 14A-14D to generate content-based index information for a file. The file may be a text file or a non-text file (e.g., an audio file, a video file, an image file, a graphics file, etc.). Each content analyzer 11A-11D performs content analysis on the content of the file. The content analysis may be any type of content analysis. Character analysis, speech analysis, video analysis, and acoustic analysis are some examples of content analysis types. Detection and recognition of alphanumeric characters, spoken words, visual elements, and music features are some examples of the content-based index information generated by content analysis.

As discussed above, generation of content-based index information, especially for non-text files, requires extensive computational resources and is time consuming. Each content analyzer 11A-11D and processor 14A-14D of respective devices 10, 20, 30, and 40 may execute content analysis on the entire content of a file. However, the greater the amount of file content, the less practical it is for each content analyzer 11A-11D and processor 14A-14D of respective devices 10, 20, 30, and 40 to be able to perform content analysis on the entire content of the file, especially in the case in which the content-based indexing is a background operation. In an embodiment, each content analyzer 11A-11D and processor 14A-14D of respective devices 10, 20, 30, and 40 execute content analysis solely on a portion of content of a file. That is, content analysis is divided into numerous content analysis tasks that are more practical for each content analyzer 11A-11D and processor 14A-14D of respective devices 10, 20, 30, and 40 to perform. Each content analysis task corresponds to performing content analysis on a different portion of the file content to generate a partial group of content-based index information. For example, 12 content analysis tasks corresponding to different 5 minute segments of a 1 hour audio file may be performed to generate 12 separate partial groups of content-based index information. The separately generated partial groups of content-based index information are combined or aggregated to form the completed content-based index information for the file.

This partial indexing may be accomplished in a coordinated manner or in an uncoordinated manner. In an embodiment, the coordinated manner involves the central index source 50 managing and controlling the division of file content into multiple portions, where the result of performing content analysis on each file content portion is a partial group of content-based index information. Thus, the central index source 50 selects and assigns one of the file content portions to a device (e.g., device A 10, device B 20, device C 30, or device D 40) in response to a request from the device, avoiding duplicate content analysis on the same file content portion. In an embodiment, the uncoordinated manner involves any device (e.g., device A 10, device B 20, device C 30, or device D 40) picking a random portion of file content, performing content analysis on the random portion to generate a partial group of content-based index information, and sharing the generated partial group of content-based index information with the central index source 50 (or the peer-to-peer network described with respect to FIG. 2 below). Thus, it is the responsibility of each device to merge the generated partial group of content-based index information with any other partial group of content-based index information generated by other devices.

Since there are many types of content analyses, it is advantageous to perform different types of content analysis on a file. In an embodiment, each content analyzer 11A-11D and processor 14A-14D of respective devices 10, 20, 30, and 40 execute the content analysis of a file to accomplish performance of several types of content analyses on the file. That is, the content-based indexing includes various index modes each corresponding to a different type of content analysis. For each index mode, there is a group of content-based index information corresponding to performance of the corresponding type of content analysis on the file. As an example, speech analysis may correspond to a first index mode, video analysis may correspond to a second index mode, and acoustic analysis may correspond to a third index mode of a multi-modal content-based index for a file. Thus, diverse index search needs may be satisfied.

This multi-modal indexing may be accomplished in a coordinated manner or in an uncoordinated manner. In an embodiment, the coordinated manner involves the central index source 50 being responsible for selecting and assigning to a device (e.g., device A 10, device B 20, device C 30, or device D 40) an index mode to generate and share in response to a request from the device, preventing duplicated effort. In an embodiment, the uncoordinated manner involves any device (e.g., device A 10, device B 20, device C 30, or device D 40) picking a random one of the index modes for which content-based index information is not currently available. The content-based index information corresponding to the randomly selected index mode is generated and shared with the central index source 50 (or the peer-to-peer network described with respect to FIG. 2 below).

Given that the accuracy of content-based index information, especially for non-text files, may vary widely, improvement of the accuracy is desirable. In an embodiment, each content analyzer 11A-11D and processor 14A-14D of respective devices 10, 20, 30, and 40 execute the content analysis of a file to accomplish performance of content analysis using different parameter settings on the file. That is, the content-based indexing includes various index manifestations each corresponding to performance of content analysis using a different parameter setting. For each index manifestation, there is a group of content-based index information corresponding to performance of content analysis using a corresponding parameter setting on the file. The various groups of content-based index information are merged to form merged content-based index information having a greater accuracy than the individual groups of content-based index information. As an example, speech recognition analysis using a Hidden Markov Model parameter setting based on conversational speech may correspond to a first index manifestation, speech recognition analysis using a Hidden Markov Model parameter setting based on broadcast news speech may correspond to a second index manifestation, and speech recognition analysis using a Hidden Markov Model parameter setting based on clean read speech may correspond to a third index manifestation of a multi-manifestation content-based index for a file. The groups of content-based index information from the first, second, and third index manifestations may be merged using a technique such as ROVER (Recognizer Output Voting Error Reduction) to form merged content-based index information having a greater accuracy than the individual groups of content-based index information from the first, second, and third index manifestations.

This multi-manifestation indexing may be accomplished in a coordinated manner or in an uncoordinated manner. In an embodiment, the coordinated manner involves the central index source 50 being responsible for selecting and assigning to a device (e.g., device A 10, device B 20, device C 30, or device D 40) an index manifestation to generate and share in response to a request from the device, avoiding duplicated effort. In an embodiment, the uncoordinated manner involves any device (e.g., device A 10, device B 20, device C 30, or device D 40) picking a random one of the index manifestations for which content-based index information is not currently available. The content-based index information corresponding to the randomly selected index manifestation is generated and shared with the central index source 50 (or the peer-to-peer network described with respect to FIG. 2 below).

The partial indexing, multi-modal indexing, and multi-manifestation indexing described above may be combined in various ways. An index mode being completed using partial indexing, an index manifestation being completed using partial indexing, and an individual index mode having various index manifestations are examples of combining the partial indexing, multi-modal indexing, and multi-manifestation indexing. Moreover, partial indexing, multi-modal indexing, and multi-manifestation indexing are realized because of distribution of the content analysis and sharing the result of the distributed content analysis.

Returning to FIG. 1, the central index source 50 includes a processor 51, an indexing unit 54, a storage unit 52, and a network communication unit 56. Moreover, the central index source 50 is coupled to the network 80 via connection 55. The connection 55 may be wired or wireless. In an embodiment, the central index source 50 is a server.

The storage unit 52 stores content-based index information for files. In an embodiment, content-based index information for the files is received from the devices 10, 20, 30, and 40. The central index source 50 may generate content-based index information for the files and store it in the storage unit 52, in an embodiment. For speed, convenience, and privacy, the received content-based index information of a file is associated with the hash of the file. Similarly, the generated content-based index information of a file is associated with the hash of the file. In an embodiment, the central index source 50 aids in coordinating the partial indexing, multi-modal indexing, and multi-manifestation indexing described above.

The indexing unit 54 is operable to utilize the processor 51 to receive requests for content-based index information for files and send content-based index information for files to devices 10, 20, 30, and 40. Further, the indexing unit 54 is operable to utilize the processor 51 to generate content-based index information for files, in an embodiment.

In an embodiment, the central index source 50 is configured to maintain an index based on the content-based index information stored in the storage unit 52 and is configured to enable searches to be performed on the index. The indexing unit 54 is further operable to utilize the processor 51 to search the network 80 (e.g., the Internet) to discover files for inclusion in scope of the index. Also, the indexing unit 54 is operable to utilize the processor 51 to receive and process the received content-based index information from the devices 10, 20, 30, and 40 to detect and to eliminate an irregularity. Examples of an irregularity include malicious index information, harmful index information, and illegitimate index information. Furthermore, the indexing unit 54 is operable to utilize the processor 51 to generate noncontent-based index information for files. Noncontent-based index information refers to index information generated from any data associated with a file, other than the file's content. Meta-data, file name, and file description are examples of sources for the noncontent-based index information. The generated noncontent-based index information may be stored in the storage unit 52 and may be part of the maintained index. Also, the generated noncontent-based index information of a file is associated with the hash of the file. Thus, for a new file included in the scope of the maintained index, the index information may be content-based index information received from the devices 10, 20, 30, and 40; may be content-based index information generated by the indexing unit 54 and the processor 51; and/or may be noncontent-based index information generated by the indexing unit 54 and the processor 51.

FIG. 2 is a block diagram of a decentralized index source environment 200, in accordance with various embodiments. The discussion with respect to FIG. 1 is applicable to FIG. 2 except as noted below. As depicted in FIG. 2, the decentralized index source environment 200 includes a plurality of devices 10, 20, 30, and 40 coupled to a network 80. The network 80 may be the Internet. The devices 10, 20, 30, and 40 may be any type of device. Computers, servers, storage media, media players, and phones are examples of device types. It should be understood that the decentralized index source environment 200 may have other configurations.

The devices 10, 20, 30, and 40 are configured as a peer-to-peer network. Each device 10, 20, 30, and 40 exposes its locally generated content-based index information to the peer-to-peer network. The locally generated content-based index information is discoverable by other devices of the peer-to-peer network through the performance of a search for the locally generated content-based index information in the peer-to-peer network. Then, the desired content-based index information is requested and received from the appropriate device(s) 10, 20, 30, and 40 of the peer-to-peer network, where the appropriate device(s) 10, 20, 30, and 40 of the peer-to-peer network are external sources of content-based index information with respect to the requesting device of the peer-to-peer network. That is, requests for content-based index information to the central index source 50 as described with respect to FIG. 1 are replaced by searches for the locally generated content-based index information in the peer-to-peer network depicted in FIG. 2. Further, transmission of content-based index information to the central index source 50 as described with respect to FIG. 1 is replaced by a publishing operation to expose the locally generated content-based index information to the peer-to-peer network depicted in FIG. 2. Thus, content-based index information is shared via the peer-to-peer network.

### Distributed Content-Based Indexing Techniques

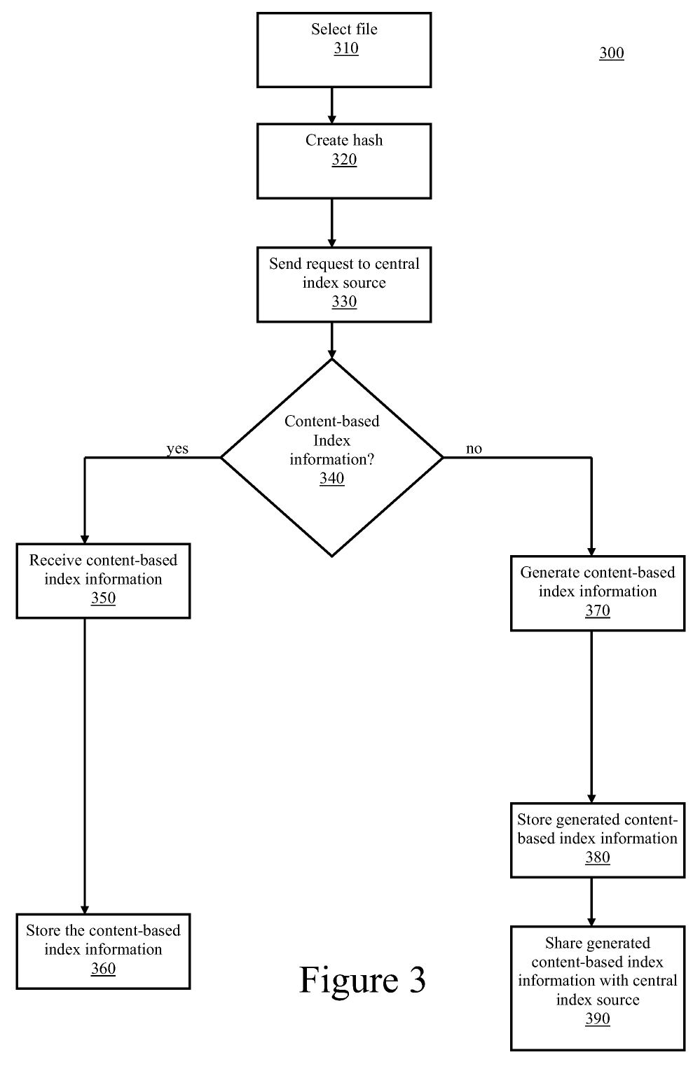

The following discussion sets forth in detail the operation of distributed content-based indexing techniques. With reference to FIGS. 3-6, flowcharts 300, 400, 500, and 600 each illustrate example steps used by various embodiments of distributed content-based indexing. Flowcharts 300, 400, 500, and 600 include processes that, in various embodiments, are carried out by a processor under the control of computer-readable and computer-executable instructions stored in any type of computer-readable medium. Although specific steps are disclosed in flowcharts 300, 400, 500, and 600, such steps are examples. That is, embodiments are well suited to performing various other steps or variations of the steps recited in flowcharts 300, 400, 500, and 600. It is appreciated that the steps in flowcharts 300, 400, 500, and 600 may be performed in an order different than presented, and that not all of the steps in flowcharts 300, 400, 500, and 600 may be performed.

FIG. 3 illustrates a flowchart 300 for content-based indexing a file, in accordance with various embodiments. For this discussion, the content-based indexing occurs in the centralized index source environment 100 described with respect to FIG. 1.

A file is selected in device A 10 for indexing (block 310). The file may be a text file or a non-text file (e.g., an audio file, a video file, an image file, a graphics file, etc.). In an embodiment, the indexing unit 17A of device A 10 selects the file.

Continuing, device A 10 creates a unique hash (e.g., a MD5 (Message-Digest algorithm 5) hash) of the selected file, where the hash is a unique identifier (block 320). In an embodiment, the indexing unit 17A creates the unique hash.

Device A 10 requests content-based index information for the selected file from the central index source 50 (block 330). In an embodiment, the indexing unit 17A requests the content-based index information. The request includes the hash of the selected file instead of the selected file. Thus, privacy and speed are maintained since the selected file is not sent to the central index source 50.

If the central index source 50 has the content-based index information for the selected file, the device A 10 receives and stores the content-based index information for the selected file from the central index source 50 (block 340, block 350, and block 360). The selected file is now searchable in device A 10 by using the received content-based index information. In an embodiment, based on the evaluation of a security feature (e.g., a digital signature) of the received content-based index information, the device A 10 decides whether to store and use the received content-based index information.

If the central index source 50 does not have the content-based index information for the selected file, the device A 10 generates and stores content-based index information for the selected file and shares the generated content-based index information with the central index source 50 (block 370, block 380, and block 390). In an embodiment, the content analyzer 11A performs content analysis on the selected file to generate the content-based index information. The content analysis may be performed on the entire content of the selected file. The selected file is now searchable in device A 10 by using the generated content-based index information. In an embodiment, the device A 10 sends the unique hash and the generated content-based index information of the selected file to the central index source 50. Thus, the generated content-based index information of the selected file is available to device B 20, device C 30, and device D 40 if requested from the central index source 50.

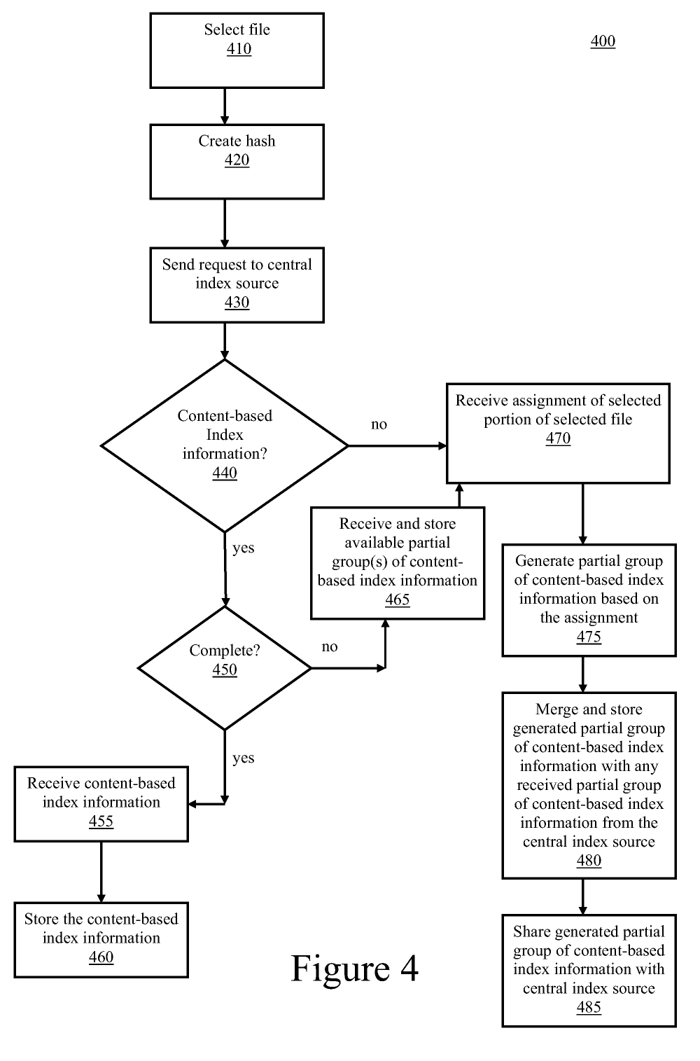

FIG. 4 illustrates a flowchart 400 for content-based indexing a file, where different portions of the file are indexed separately, in accordance with various embodiments. That is, the partial indexing technique described above is shown in FIG. 4. For this discussion, the content-based indexing occurs in the centralized index source environment 100 described with respect to FIG. 1.

A file is selected in device A 10 for indexing (block 410). The file may be a text file or a non-text file (e.g., an audio file, a video file, an image file, a graphics file, etc.). In an embodiment, the indexing unit 17A of device A 10 selects the file.

Continuing, device A 10 creates a unique hash (e.g., a MD5 (Message-Digest algorithm 5) hash) of the selected file, where the hash is a unique identifier (block 420). In an embodiment, the indexing unit 17A creates the unique hash.

Device A 10 requests content-based index information for the selected file from the central index source 50 (block 430). In an embodiment, the indexing unit 17A requests the content-based index information. The request includes the hash of the selected file instead of the selected file. Thus, privacy and speed are maintained since the selected file is not sent to the central index source 50.

If the central index source 50 has the content-based index information for the selected file and the content-based index information is complete, the device A 10 receives and stores the content-based index information for the selected file from the central index source 50 (block 440, block 450, block 455, and block 460). The selected file is now searchable in device A 10 by using the received content-based index information. Similarly to the discussion with respect to FIG. 3, the device A 10 decides whether to store and use the received content-based index information based on the evaluation of a security feature (e.g., a digital signature) of the received content-based index information, in an embodiment.

If the central index source 50 does not have the content-based index information for the selected file or if the content-based index information for the selected file is not complete, the central index source 50 selects a portion of the selected file, assigns the device A 10 a content analysis task corresponding to performing content analysis on the selected portion of the file content to generate a partial group of content-based index information, and sends any available partial groups of content-based index information from already performed content analysis tasks (block 440, block 450, block 465, and block 470). For example, the portion may be a finite segment (e.g., a 5 minute segment) of a non-text file (e.g., audio file, video file, etc.).

One benefit of the partial indexing technique of FIG. 4 is the fact that the selected file is now searchable in device A 10 to the extent of any available partial groups of content-based index information from already performed content analysis tasks sent to the device A 10. That is, it is not necessary to wait until the entire selected is indexed before being able to perform searches on the selected file. This reduces the lag time between time at which the selected file is available and time at which the selected file may be searched.

The device A 10 performs content analysis on the selected portion (e.g., a 5 minute segment) of the file content to generate a partial group of content-based index information (block 475). Moreover, the device A 10 merges and stores the generated partial group of content-based index information with any received partial group of content-based index information from the central index source 50 and shares the generated partial group of content-based index information with the central index source 50 (block 480 and block 485). In an embodiment, the content analyzer 11A performs content analysis on the selected portion of the file content. The selected file is now further searchable in device A 10 to the extent of the generated partial group of content-based index information. In an embodiment, the device A 10 sends the unique hash and the generated partial group of content-based index information of the selected file to the central index source 50. The central index source 50 combines the generated partial group of content-based index information with any available partial groups of content-based index information from already performed content analysis tasks. If the combination indicates completion of content-based index information for the selected file, the central index source 50 designates the selected file as having completed content-based index information. Also, the generated partial group of content-based index information of the selected file is available to device B 20, device C 30, and device D 40 if requested from the central index source 50. In an embodiment, if the content-based index information for the selected file is not complete, the device A 10 schedules a periodic check for new partial group(s) of content-based index information in the central index source 50.

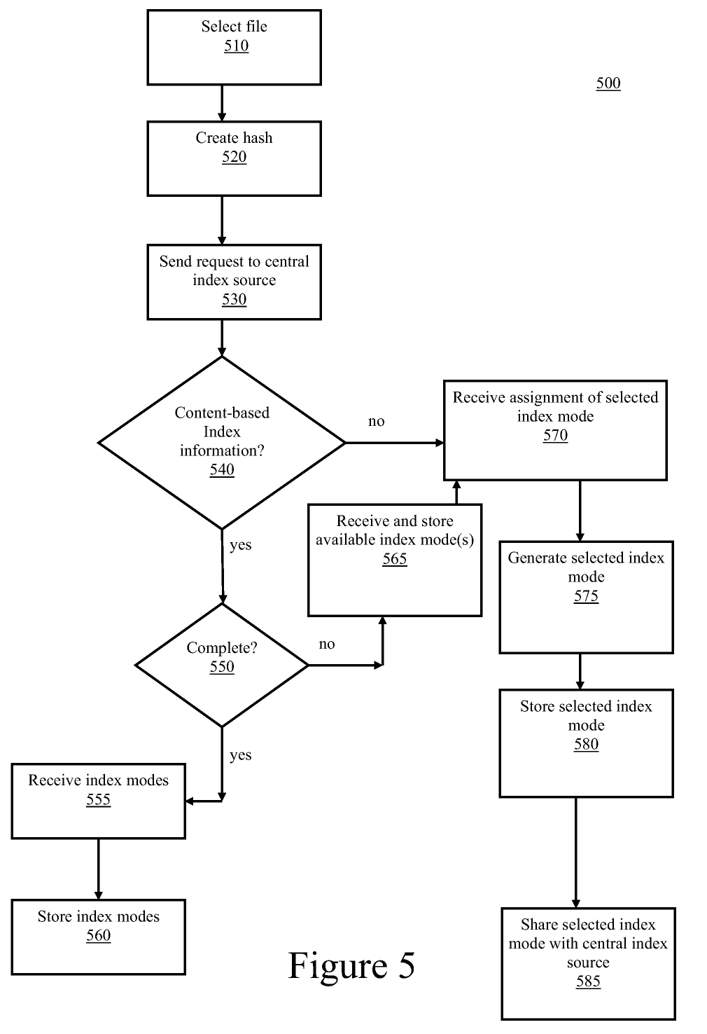

FIG. 5 illustrates a flowchart 500 for content-based indexing a file, where the content-based indexing includes various index modes each corresponding to a different type of content analysis, in accordance with various embodiments. That is, the multi-modal indexing technique described above is shown in FIG. 5. For this discussion, the content-based indexing occurs in the centralized index source environment 100 described with respect to FIG. 1. Index modes are defined. That is, the number (e.g., three) of index modes and the content analysis type (e.g., speech analysis, video analysis, and acoustic analysis) for each mode are specified.

A file is selected in device A 10 for indexing (block 510). The file may be a text file or a non-text file (e.g., an audio file, a video file, an image file, a graphics file, etc.). In an embodiment, the indexing unit 17A of device A 10 selects the file.

Continuing, device A 10 creates a unique hash (e.g., a MD5 (Message-Digest algorithm 5) hash) of the selected file, where the hash is a unique identifier (block 520). In an embodiment, the indexing unit 17A creates the unique hash.

Device A 10 requests each index mode for the selected file from the central index source 50 (block 530), where for each index mode, there is a group of content-based index information corresponding to performance of the corresponding type of content analysis on the selected file. In an embodiment, the indexing unit 17A requests each index mode for the selected file. The request includes the hash of the selected file instead of the selected file. Thus, privacy and speed are maintained since the selected file is not sent to the central index source 50.

If the central index source 50 has index modes for the selected file and the index modes are complete, the device A 10 receives and stores the groups of content-based index information for the index modes from the central index source 50 (block 540, block 550, block 555, and block 560). The selected file is now searchable in device A 10 to the extent of the groups of content-based index information for the index modes sent by the central index source 50. Similarly to the discussion with respect to FIGS. 3 and 4, the device A 10 decides whether to store and use the received groups of content-based index information for the index modes based on the evaluation of a security feature (e.g., a digital signature) of the received groups of content-based index information, in an embodiment.

If the central index source 50 does not have index modes for the selected file or if the index modes are not complete, the central index source 50 selects an index mode for the selected file, assigns the device A 10 performance of the type of content analysis on the selected file corresponding to the selected index mode to generate a group of content-based index information for the selected index mode, and sends the groups of content-based index information for any available index modes (block 540, block 550, block 565, and block 570). The selected file is now searchable in device A 10 to the extent of any groups of content-based index information for any available index modes sent by the central index source 50.

The device A 10 performs content analysis corresponding to the selected index mode (e.g., speech analysis) on the file content to generate and store a group of content-based index information for the selected index mode and shares the generated group of content-based index information for the selected index mode with the central index source 50 (block 575, block 580, and block 585). In an embodiment, the content analyzer 11A performs content analysis corresponding to the selected index mode. The selected file is now further searchable in device A 10 to the extent of the generated group of content-based index information for the selected index mode. In an embodiment, the device A 10 sends the unique hash and the generated group of content-based index information for the selected index mode to the central index source 50. The central index source 50 collects the generated group of content-based index information for the selected index mode with any group of content-based index information for any available index mode for the selected file. If the collection indicates completion of the index modes for the selected file, the central index source 50 designates the selected file as having completed index modes. Also, the generated group of content-based index information for the selected index mode of the selected file is available to device B 20, device C 30, and device D 40 if requested from the central index source 50. In an embodiment, if the index modes for the selected file are not complete, the device A 10 schedules a periodic check for new group(s) of content-based index information for index modes of the selected file in the central index source 50.

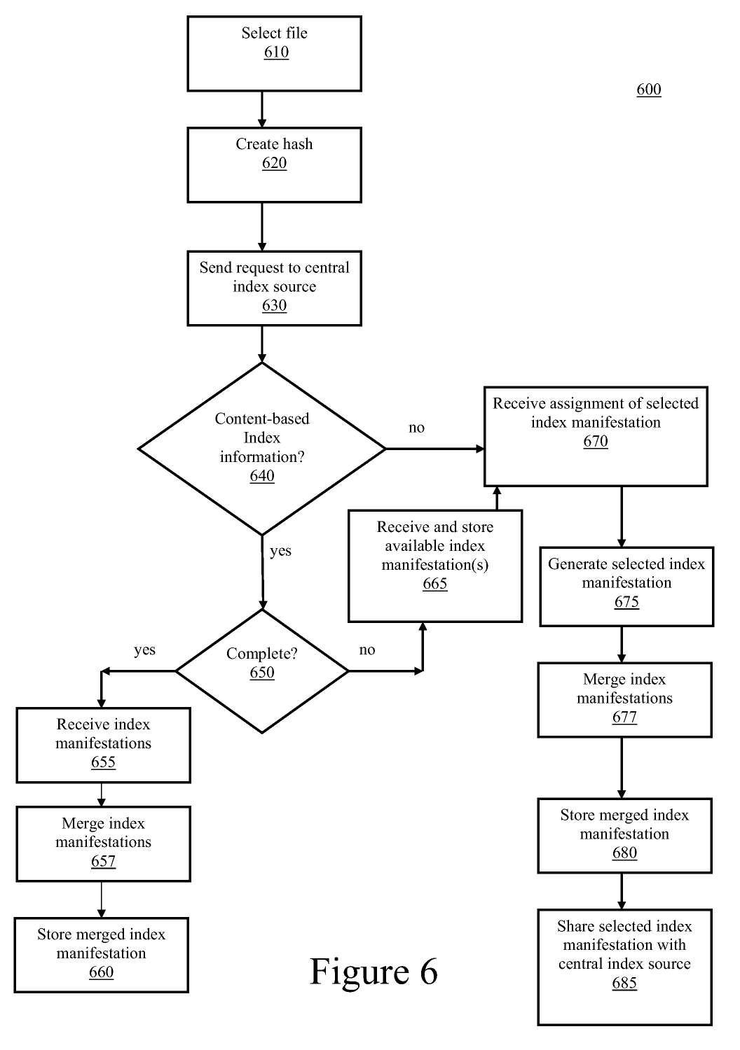

FIG. 6 illustrates a flowchart 600 for content-based indexing a file, where the content-based indexing includes various index manifestations each corresponding to performance of content analysis using a different parameter setting, in accordance with various embodiments. That is, the multi-manifestation indexing technique described above is shown in FIG. 6. For this discussion, the content-based indexing occurs in the centralized index source environment 100 described with respect to FIG. 1. Index manifestations are defined. That is, the number (e.g., three) of index manifestations, the content analysis type (e.g., speech recognition analysis), and the parameter settings (e.g., a Hidden Markov Model parameter setting based on conversational speech, a Hidden Markov Model parameter setting based on broadcast news speech, and a Hidden Markov Model parameter setting based on clean read speech) for each index manifestation are specified.

A file is selected in device A 10 for indexing (block 610). The file may be a text file or a non-text file (e.g., an audio file, a video file, an image file, a graphics file, etc.). In an embodiment, the indexing unit 17A of device A 10 selects the file.

Continuing, device A 10 creates a unique hash (e.g., a MD5 (Message-Digest algorithm 5) hash) of the selected file, where the hash is a unique identifier (block 620). In an embodiment, the indexing unit 17A creates the unique hash.

Device A 10 requests each index manifestation for the selected file from the central index source 50 (block 630), where for each index manifestation, there is a group of content-based index information corresponding to performance of content analysis using a corresponding parameter setting on the selected file. The various groups of content-based index information are merged to form merged content-based index information having a greater accuracy than the individual groups of content-based index information. In an embodiment, the indexing unit 17A requests each index manifestation for the selected file. The request includes the hash of the selected file instead of the selected file. Thus, privacy and speed are maintained since the selected file is not sent to the central index source 50.

If the central index source 50 has index manifestations for the selected file and the index manifestations are complete, the device A 10 receives and merges the groups of content-based index information for the index manifestations from the central index source 50 to form merged content-based index information and stores the merged content-based index information (block 640, block 650, block 655, block 657, and block 660). The selected file is now searchable in device A 10 to the extent of the merged content-based index information. Similarly to the discussion with respect to FIGS. 3, 4, and 5, the device A 10 decides whether to store and use the received groups of content-based index information for the index manifestations based on the evaluation of a security feature (e.g., a digital signature) of the received groups of content-based index information for the index manifestations, in an embodiment.

If the central index source 50 does not have index manifestations for the selected file or if the index manifestations are not complete, the central index source 50 selects an index manifestation for the selected file, assigns the device A 10 performance of content analysis using the parameter setting corresponding to the selected index manifestation to generate a group of content-based index information for the selected index manifestation, and sends the groups of content-based index information for any available index manifestations (block 640, block 650, block 665, and block 670). The selected file is now searchable in device A 10 to the extent of any groups of content-based index information for any available index manifestations sent by the central index source.

The device A 10 performs content analysis using the parameter setting corresponding to the selected index manifestation (e.g., a Hidden Markov Model parameter setting based on conversational speech) on the file content to generate a group of content-based index information for the selected index manifestation, merges the generated group of content-based index information for the selected index manifestation with any received groups of content-based index information for any available index manifestations to form merged content-based index information, stores the merged content-based index information, and shares the generated group of content-based index information for the selected index manifestation with the central index source 50 (block 675, block 677, block 680, and block 685). In an embodiment, the content analyzer 11A performs content analysis using parameter setting corresponding to the index mode. The selected file is now further searchable in device A 10 to the extent of the generated group of content-based index information for the selected index manifestation. In an embodiment, the device A 10 sends the unique hash and the generated group of content-based index information for the selected index manifestation to the central index source 50. The central index source 50 collects the generated group of content-based index information for the selected index manifestation with any group of content-based index information for any available index manifestation for the selected file. If the collection indicates completion of the index manifestations for the selected file, the central index source 50 designates the selected file as having completed index manifestations. Also, the generated group of content-based index information for the selected index manifestation of the selected file is available to device B 20, device C 30, and device D 40 if requested from the central index source 50. In an embodiment, if the index manifestations for the selected file are not complete, the device A 10 schedules a periodic check for new group(s) of content-based index information for index manifestation of the selected file in the central index source 50.

It is also possible for the central index source 50 to merge the various index manifestations for a file, in an embodiment. Thus, the central index source 50 may send the merged index manifestation for a file to device A 10 instead of sending the individual index manifestations. Moreover, the central index source 50 may merge the index manifestation received from device A 10 with any other index manifestation or merged index manifestation for the file.

The various embodiments provide numerous benefits. Content-based indexing of text and non-text files is made feasible and practical. Time and computational burden may be flexibly distributed to permit varying of the content-based index information for accuracy and diversity purposes. Collaboration of multiple devices avoids need for investment in large indexing-dedicated computational resources. This collaboration may be coordinated or uncoordinated as discussed above.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method of content-based indexing a file, said method comprising:
determining whether content-based index information for said file is available from an external source;
if said content-based index information for said file is available from said external source, receiving and storing said content-based index information from said external source; and
if occurrence of any one of said content-based index information for said file is not available from said external source and said content-based index information for said file is not complete, generating and storing content-based index information for said file and sharing said generated content-based index information with said external source.

2. The method as recited in claim 1 wherein said generating and storing said content-based index information for said file comprises:
performing content analysis on entire content of said file to generate said content-based index information.

3. The method as recited in claim 1 wherein said generating and storing said content-based index information for said file comprises:
performing content analysis solely on a portion of content of said file to generate said content-based index information.

4. The method as recited in claim 1 wherein said received content-based index information for said file comprises content-based index information generated by performance of a first type of content analysis, and wherein said generating and storing said content-based index information for said file comprises:
performing a second type of content analysis on at least a portion of content of said file to generate said content-based index information.

5. The method as recited in claim 1 wherein said received content-based index information for said file comprises content-based index information generated by performance of content analysis using a first parameter setting, and wherein said generating and storing said content-based index information for said file comprises:
performing content analysis using a second parameter setting on at least a portion of content of said file to generate said content-based index information.

6. The method as recited in claim 5 wherein said generating and storing said content-based index information for said file further comprises:
merging said received content-based index information and said generated content-based index information to form merged content-based index information having greater accuracy than accuracy of said received content-based index information and accuracy of said generated content-based index information.

7. The method as recited in claim 1 further comprising:
creating a unique identifier for said file that does not disclose content of said file; and
associating said unique identifier with said received content-based index information and said generated content-based index information.

8. The method as recited in claim 1 further comprising:
before storing said received content-based index information, evaluating a first security feature of said received content-based index information to determine whether to store said received content-based index information; and
adding a second security feature to said generated content-based index information.

9. The method as recited in claim 1 wherein said external source comprises a server.

10. The method as recited in claim 1 wherein said external source comprises a device of a peer-to-peer network.

11. A method of creating an index for files, said method comprising:
receiving and storing content-based index information for said files; and
generating and storing content-based index information for said files, wherein said index comprises said received content-based index information and said generated content-based index information.

12. The method as recited in claim 11 further comprising:
processing said received content-based index information to detect and to eliminate an irregularity.

13. The method as recited in claim 11 further comprising:
generating and storing noncontent-based index information for said files.

14. The method as recited in claim 13 wherein said index further comprises said noncontent-based index information.

15. An apparatus comprising:
a processor;
an indexing unit operable to utilize said processor to request and receive content-based index information for files from an external source, generate content-based index information for files, and create an index comprising said received content-based index information and said generated content-based index information; and
a storage unit operable to store said received content-based index information and said generated content-based index information.

16. The apparatus as recited in claim 15 wherein said indexing unit comprises:
a content analyzer operable to utilize said processor to generate content-based index information for a file; and
a search unit operable to utilize said processor to search said index.

17. The apparatus as recited in claim 15 wherein said indexing unit is further operable to utilize said processor to generate noncontent-based index information for files.

18. The apparatus as recited in claim 17 wherein said index further comprises said noncontent-based index information.

19. The apparatus as recited in claim 15 wherein said indexing unit is further operable to utilize said processor to process said received content-based index information to detect and to eliminate an irregularity.

20. The apparatus as recited in claim 15 wherein said indexing unit is further operable to utilize said processor to search a network to discover files for inclusion in scope of said index.
